(19) United States
(12) Patent Application Publication
(10) Pub. No.: US 2026/0299217 A1
(43) Pub. Date: Oct. 1, 2026

(54) Multi-Core Optical Cable Adapter

(71) Applicant: Go!Foton Holdings, Inc., Somerset, NJ (US)

(72) Inventors: Kenichiro Takeuchi, North Brunswick, NJ (US); Kenichiro Nakamura, San Diego, CA (US)

(73) Assignee: Go!Foton Holdings, Inc., Somerset, NJ (US)

(21) Appl. No.: 19/570,346

(22) Filed: Mar. 18, 2026

Related U.S. Application Data
(60) Provisional application No. 63/777,140, filed on Mar. 25, 2025.

(51) Int. Cl. G02B 6/38; G02B 6/02; G02B 6/40

(52) U.S. Cl. CPC G02B 6/3885; G02B 6/02042; G02B 6/3825; G02B 6/3893; G02B 6/40

(57) ABSTRACT

An optical fiber adapter is configured to connect with an optical fiber having multiple cores and convert the multi-core fiber to a plurality of single-core fibers. The adapter is configured so as to translationally and rotationally align optical cores within the adapter with cores of the connected multi-core fiber.

### CROSS-REFERENCE TO RELATED APPLICATIONS

This application claims the benefit of the filing date of U.S. provisional Patent Application No. 63/777,140, filed on Mar. 25, 2025, the disclosure of which is hereby incorporated herein by reference.

### FIELD OF THE INVENTION

The present disclosure relates generally to optical cables and assemblies and, in particular, connectors for multi-core optical cables.

### BACKGROUND OF THE INVENTION

In optical systems, optical cables are connected to adapters that are configured to receive the optical cables. A splitter can be used to convert a single optical signal into a plurality of identical optical signals. However, splitters and other available adapters are not configured to effectively connect and divide a multi-core fiber into a plurality of single-core fibers. Accordingly, there is a need for alternative optical cable configurations to allow for efficient and effective connections between devices having single-core optical fibers and a multi-core optical fiber input.

### BRIEF SUMMARY OF THE INVENTION

In accordance with aspects of the disclosure, a fiber optic system may include: a multi-core fiber adapter having a multi-core single-fiber connector and a multi-fiber connector; a cover including a first end and a second end and defining a longitudinal axis, wherein the multi-core fiber connector is arranged at the first end along the longitudinal axis and the multi-fiber connector is arranged at the second end along the longitudinal axis; a single multi-core optical fiber positioned within the cover along the longitudinal axis and at least partially received in the multi-core fiber connector; and a multi-core divider positioned within the cover along the longitudinal axis configured to receive an end of the single multi-core optical fiber, wherein the multi-core divider is configured to divide the single multi-core optical fiber into a plurality of single-core optical fibers. In addition, the multi-core fiber connector may be configured so as to arrange cores of the single multi-core optical fiber with respect to cores of a connected input cable.

In accordance with other aspects of the disclosure, the connected input cable may further include an input connector that is configured to connect with multi-core single-fiber connector. The input connector and the multi-core single-fiber connector may also be configured so that cores of the input cable are aligned with cores of the single multi-core optical fiber.

In accordance with still other aspects of the disclosure, alignment of the input cable and the single multi-core optical fiber may include rotational alignment of cores within the input cable and cores within the single multi-core optical fiber.

In accordance with still other aspects of the disclosure, the single multi-core optical fiber contains four optical cores and the multi-core divider may be configured to divide the single multi-core optical fiber into four single-core optical fibers.

In accordance with other aspects of the disclosure, each core of the single multi-core optical fiber may be configured to transmit a distinct optical signal.

In accordance with still other aspects of the disclosure, the connected input cable may be connected to the multi-core fiber adapter by an LC connector.

In accordance with yet other aspects of the disclosure, the plurality of single-core optical fibers may each be arranged to have an end at a multi-fiber connector. In addition, the multi-fiber connector may be an MPO connector.

### BRIEF DESCRIPTION OF THE DRAWINGS

By way of example only, embodiments of the present disclosure will be described herein with reference to the accompanying drawings, in which:

FIG. 1 is a perspective view of an adapter component for dividing a multi-core fiber into a plurality of single-core fibers in accordance with aspects of the disclosure;

FIG. 2 is an exploded view of an adapter component of FIG. 1, in accordance with aspects of the disclosure;

FIG. 3 is perspective view of an input multi-core optical fiber that can be connected to adapter component shown in FIG. 1, in accordance with aspects of the disclosure;

FIG. 4 is a diagram of an input multi-core optical fiber and an adapter component in accordance with aspects of the disclosure.

FIG. 5 is a perspective view of a multi-core optical fiber connector in accordance with aspects of the disclosure.

FIG. 6 is a perspective view of a multi-core optical fiber connector having a rotatable ferrule alignment in accordance with aspects of the disclosure.

FIG. 7 is a diagram of a multi-core shuffle adapter in accordance with aspects of the disclosure.

FIG. 8 is a diagram of another multi-core shuffle adapter in accordance with aspects of the disclosure.

FIG. 9 is a diagram of a multi-fiber shuffle adapter in accordance with aspects of the disclosure.

### DETAILED DESCRIPTION

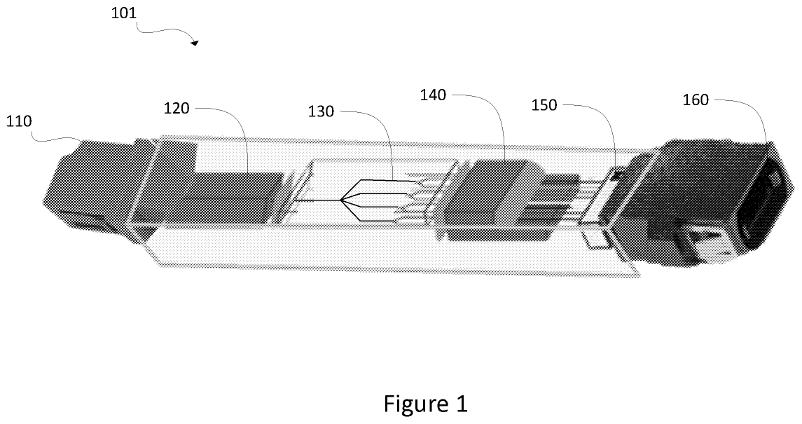

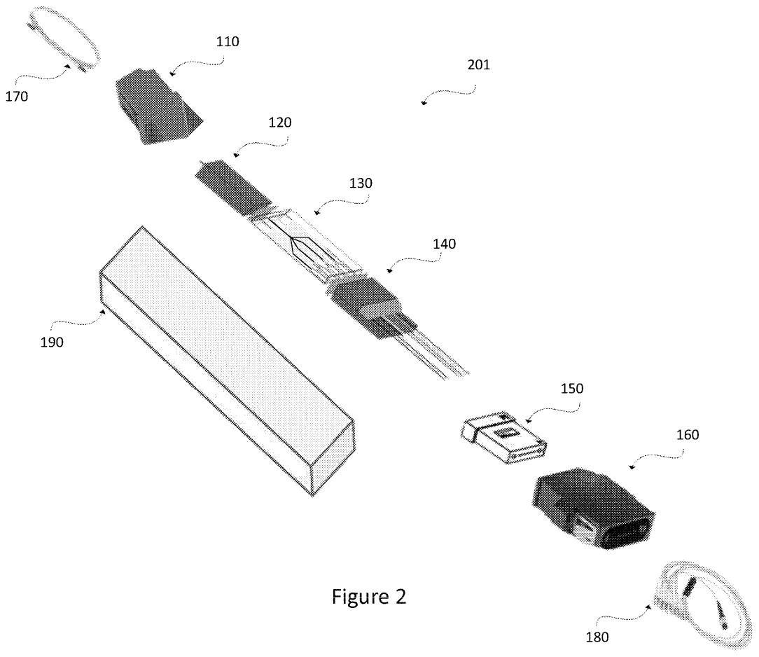

Referring now to the drawings, as shown in FIGS. 1 and 2, a multi-core divider component integrated adapter 101 includes an adapter 110, multi-core single fiber assembly 120 having a first end mated to an inner end of the LC adapter, multi-core divider 130 having a first end mated to a single fiber end of the single fiber assembly, multi-fiber ribbon assembly 140 having a closed end mated to a multi-fiber end of the divider 130, mechanical transfer (MT) ferrule 150 having an inner end mated to an open end of the multi-fiber ribbon assembly 140, and mechanical push-on (MPO) connector 160 having an inner end for receipt of an outer end of the MT ferrule. An LC input cable 170 having a multi-core optical fiber may be inserted into an outer end of adapter 110 opposite the inner end of the adapter to form an input cable with connector, the connector being an outer end of MPO connector 160 opposite the inner end of the MPO adapter. As further shown, MPO breakout cable 180 may be inserted into the outer end of MPO connector 160 to form an output cable. LC input and MPO breakout cables 170, 180 may be inserted into the outer ends of integrated adapter 101 to form multi-core-to-divided-single-core cable 201. In this manner, integrated adapter 101 serves to convert a single fiber having a plurality of optical signals, e.g., optical input within a single fiber having a plurality of optical cores, along a single fiber of LC input cable 170, to a plurality of single-core fibers. The MPO connectors described herein can take the form of varying types of connectors, such as for example, MMC connectors, SN-MT connectors, or other multi-fiber connectors and other multi-fiber ferrules that are used for optical connections.

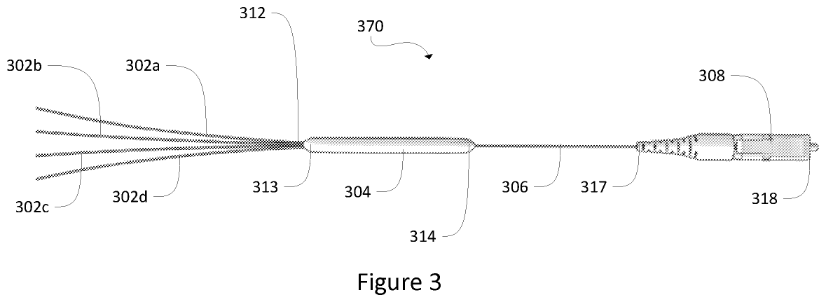

In accordance with aspects of the disclosure, the input cable 170 may take the form of a multi-core optical cable that is integrated with a plurality of single-core fibers. For example, FIG. 3 is a view of an input cable 370 that includes pigtail optical fibers 302a-d. These pigtail optical fibers 302a-d can be configured to each be a standard single-core optical fiber, and each optical core of fibers 302a-d can be combined into a single optical fiber 306, which is a multi-core fiber that contains optical cores that correspond with each optical core of fibers 302a-d. For example, pigtail optical fibers 302a-d may each have a proximal end 312 that is fed into a distal end 313 of optical core combiner 304. The combiner 314 integrates the optical core of each optical fiber 302a-d into a single multi-core fiber 306. The proximal end 317 of the multi-core fiber 306 may be integrated into a connector 308, which contains a proximal end 318 that is configured to connect with a multi-core connector. The length of pigtails 302a-d may vary depending on the particular application. For example, certain data center applications may require pigtail lengths of between 1 and 10 meters, with a 900 μm furcation tube.

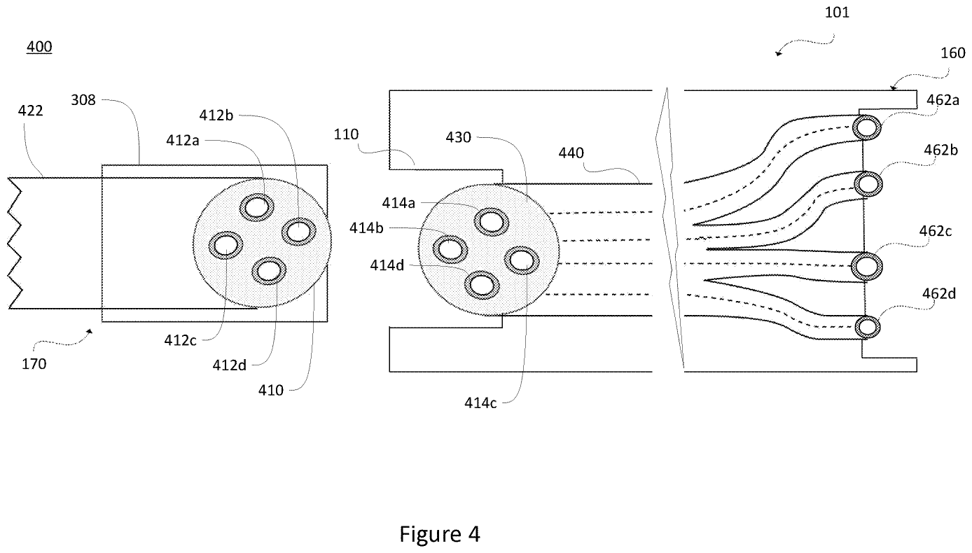

FIG. 4 is a diagram 400 of an adapter 101 and input cable 170 in accordance with aspects of the disclosure. As discussed above, input cable 170 is a single fiber having a plurality of optical cores 412a-d, which are configured within connector 308 so as to be connectable with connector 110 of adapter 101. Each optical core 412a-d is configured to transmit one or more optical signals, and each of the signals in optical cores 412a-d may correspond to or differ from one another. The optical cores 412a-d may be surrounded by a jacket 422 that maintains the cross-sectional position of the cores relative to one another. Jacket 422 may be but is not limited to being made of a flexible plastic material such as but not limited to polyvinyl chloride (PVC).

In connecting with input cable 170, connector 110 of adapter 101 and connector 308 of input cable 170 may be configured to align each of the optical cores 414a-d with a corresponding optical core 412a-d. Accordingly, when connector 308 is connected within connector 110 of adapter 101, the end 410 of input cable 170 is aligned with the end 430 of fiber 440 within adapter 101. This alignment centers end 410 with end 403 with respect to the cross-sectional plane of each fiber. In addition, connector 308 and connector 110 also rotationally align the two fibers, so that each core 412a-d rotationally aligns with a corresponding core 414a-d. For example, core 412a may be positioned within connector 308 so that when connector 308 is place within connector 110, core 412a is aligned with core 414a of adapter 101. The alignment of connector 308 with connector 110 can ensure low-loss connectivity between input cable 170 and adapter 101, and produce precision ferrule alignment.

As shown in diagram 400, adapter 101 is configured to divide the optical cores 414a-d of fiber 440 into a plurality of single-core fibers 462a-d. The ends of fibers 462a-d may be positioned with respect to connector 160 of adapter 101, so that a multi-fiber connector can be used to connect each of the fibers 462a-d. The connections with the individual fibers 462a-d may then be provided to different devices (not shown) within the system. Accordingly, adapter 101 allows for a compact distribution of optical signals from a single multi-core fiber to a plurality of single core fibers. More over adapter 101 can be configured to connect with existing single-core fibers, allows for implementation of adapter 101 with existing systems, such as in data centers and telecom centers.

In accordance with aspects of the disclosure, the operating wavelength of the multi-core fiber may vary with respect to each core. In addition, each core may be configured to transmit a plurality of wavelengths. These wavelengths may be selected to optimized for particular applications. For example, for certain data center applications, the operating wavelength may be between 1310 nm and 1550 nm. In diagram 400 of FIG. 4, input cable 170 and adapter 101 are configured for transmission of optical data over four optical cores. Accordingly, the bandwidth of data can potentially reach four times that of a single-core fiber.

A different number of cores may be present within input cable 170 and fiber 440 of adapter 101, such has having multi-core fibers with 16 cores or more. Multi-core fibers may be used in a number of applications, including data centers and telecom communication hubs, which require efficient and reliable transmission of data at high bandwidths.

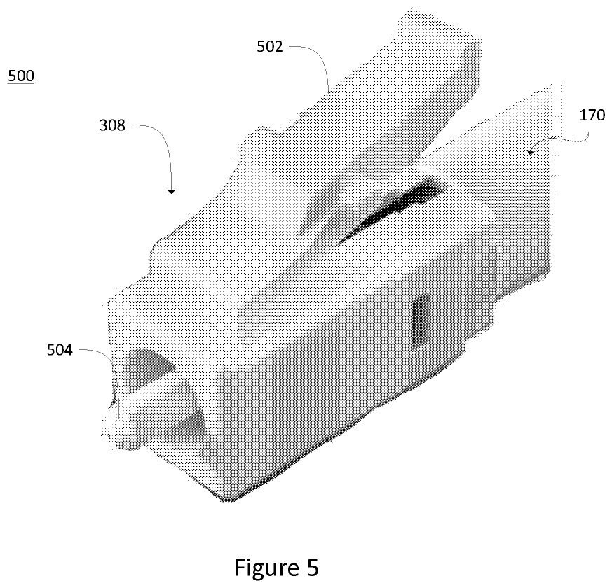

FIG. 5 is a view of a rendering 500 of connector 308 for a multi-core fiber 170. A ferrule extension 504 may extend from connector 308, and an engaging clasp 502 may extend from the body of connector 308. Ferrule extension 504 can be configured to align input cable 170 with a device with which input cable 170 is connected. For example, as discussed in connection with FIG. 4, connector 308 is configured to translationally and rotationally align cores 412a-d of input cable 170 with cores 414a-d of adapter 101. In addition, engaging clasp 502 of FIG. 5 is configured to flexibly engage and lock into place with a portion of female connector, such as connector 110 of adapter 101 shown in FIGS. 1, 2, and 4.

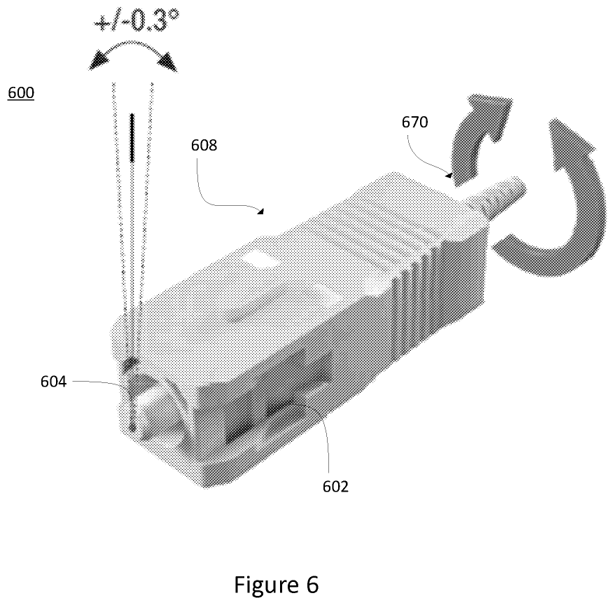

FIG. 6 is a view of a rending 600 of a connector 608 for a multi-core input cable 670 in accordance with aspects of the disclosure. Ferrule extension 604 is provide for aligning input cable 670 with respect to a connected device. As shown in rendering 600, ferrule extension 604 is configured with a ferrule rattling tolerance of +/−0.3 degrees, so as to allow for precision ferrule alignment. In addition, the connector 608 can be configured to allow for the ferrule to be freely rotated 360 degrees for precise alignment and secure fixation with respect to the connected device. In addition, connector 608 contains a clasp-receiving region 602, which can be configured to receive and lock with respect to a clasp on a connected device. Accordingly, connector 608 allows for secure connection and alignment with respect to the multi-core input cable and the cores of a connected device in accordance with aspects of the disclosure.

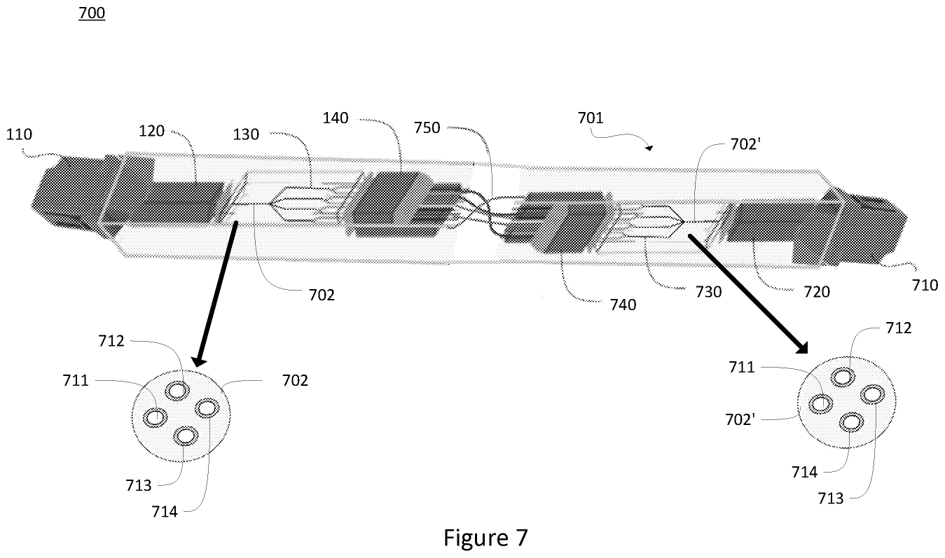

In accordance with aspects of the disclosure, an multi-core adapter may be configured to rearrange or shuffle the optical cores that are within a fiber. For example, FIG. 7 is a diagram 700 of a core shuffle adapter 701 that has a connector 110 that can receive a multi-core fiber having a particular arrangement of optical cores and can provide an output via connector 710 for an optical fiber in which the optical cores have been rearranged.

In particular, shuffle adapter 701 can be configured to alter the relative position of the optical signals being transmitted within a multi-core fiber input. For example, multi-core single fiber assembly 120 has an optical fiber 702 and as shown in diagram 700, the optical fiber 702 contains four optical cores 711-714. These cores 711-714 can each be numbered or otherwise identified based on the particular optical signal that is being transmitted through each core 711-714. Multi-core divider 130 is configured to have a first end mated to the single multi-core fiber 702 and a second end mated to a first multi-fiber ribbon assembly 140. The first multi-fiber ribbon assembly 140 are connected via router 750 to a second multi-fiber ribbon assembly 740. Within router 750, the relative positions of each optical core can be rearranged, and the second multi-fiber ribbon assembly can provide an output to a multi-core recombiner 730, which is configured to combine each optical core into a single multi-core fiber 702′. The multi-core fiber 702′ can then be connected to fiber assembly 720 that is mated with a connector 710 that is configured to connect with another multi-core fiber (not shown).

In rearranging the optical cores 711-714, the shuffle adapter 701 alters the relative positions of the signals being carried along each optical core change. For example, diagram 700 contains a cross-sectional representations of multi-core fiber 702 and 702′. As shown in the two cross-sectional representations, the optical cores 713 and 714 have switched locations with one another, indicating that the relative positions of the optical signals being transmitted within optical cores 713 and 714 have switched relative locations with one another. Accordingly, shuffle adapter 701 is configured to receive a multi-core fiber 702 that has a first configuration of optical core signals and can output a multi-core fiber 702′ that has a different configuration of optical core signals. In addition the rearrangement of the optical cores can be configurable so as to allow any configuration of optical cores to be rearranged to any other configuration of optical cores. For example, router 750 may include configurable connections between each of the optical cores within shuffle adapter 701.

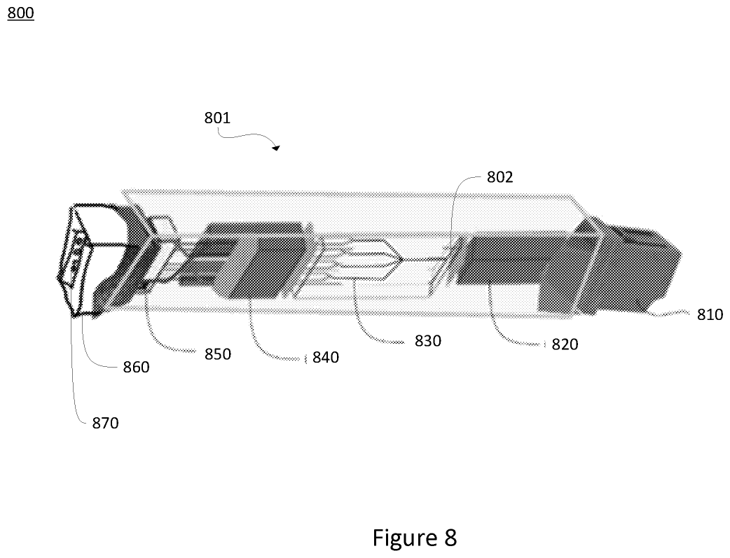

FIG. 8 is shuffle adapter 801 that is configured to be connectable with another adaptor, such as adaptor 101 of FIG. 1. For example, connector 860 of shuffle adapter 801 can be configured to connect with connector 160 of adapter 101. As described above, connector 160 provides a plurality of single core fibers, and the single core fibers can be received by plurality of optical core receivers 870 within connector 860 of shuffle adapter 801. These optical cores can then be rearranged within router 850 and provided to multi-fiber ribbon assembly 840 in a desired configuration. Multi-fiber ribbon assembly 840 is configured to provide an output for each of the plurality of cores to multi-core recombiner 830. Multicore recombiner 830 combines the output of each core into one of the cores of a multi-core fiber 802, which is connected to a fiber assembly 820.

In addition, fiber assembly 820 is mated with a connector 810, which is configured to connect with another multi-core fiber (not shown). In accordance with aspects of the disclosure, the combination of adaptor 101 of FIG. 1 and shuffle adaptor 801 can result in a rearrangement of optical cores within a multi-core fiber. For example, a multi-core fiber input may be provided to connector 110 of adapter 101, and connector 160 of adapter 101 may be connected to connector 860 of shuffle adapter 801 of FIG. 8. Shuffle adapter is then configured to rearrange the cores of the multi-core fiber input so as to produce a rearrangement of optical cores within the multi-core fiber output at connector 810. In accordance with aspects of the disclosure, connector 870 and router 850 may be configurable, so as to allow for different rearrangements of optical cores within the multi-core fiber.

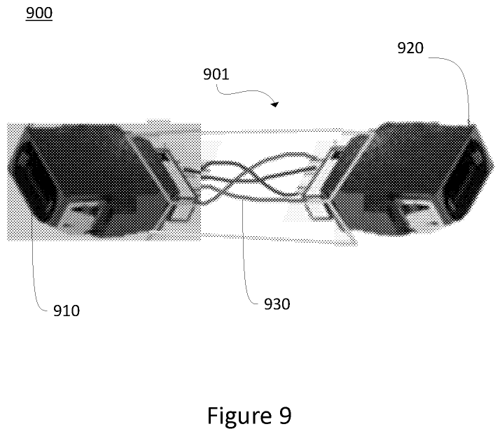

In accordance with aspects of the disclosure, a multiple-fiber connector can be used to rearrange the relative positions of optical fibers. For example, FIG. 9 is a diagram 900 of a multi-fiber adapter 901, which contains two multi-fiber connectors 910 and 920. Multi-fiber connector 910 can be configured to act as a multi-fiber input, which connects to a plurality of optical fibers, and multi-fiber connector 920 can be configured to act as a multi-fiber output. Connectors 910 and 920 are each optically connected to one another via router 930, which rearranges the relative positions of the optical fibers, so as to produce a multi-fiber output at connector 920 that has a different arrangement of optical fibers than the arrangement of optical fibers at connector 910.

It is to be further understood that the disclosure set forth herein includes any possible combinations of the particular features set forth above, whether specifically disclosed herein or not. For example, where a particular feature is disclosed in the context of a particular aspect, arrangement, configuration, or embodiment, that feature can also be used, to the extent possible, in combination with and/or in the context of other particular aspects, arrangements, configurations, and embodiments of the technology, and in the technology generally.

Furthermore, although the technology herein has been described with reference to particular features, it is to be understood that these features are merely illustrative of the principles and applications of the present technology. It is therefore to be understood that numerous modifications, including changes in the sizes of the various features described herein, may be made to the illustrative embodiments set forth above and that other arrangements may be devised without departing from the spirit and scope of the present technology. In this regard, the present technology encompasses numerous additional features in addition to those specific features set forth herein. Moreover, the foregoing disclosure should be taken by way of illustration rather than by way of limitation as the present invention is defined by the claims set forth below.

1. A fiber optic system comprising:
a multi-core fiber adapter having a multi-core single-fiber connector and a multi-fiber connector;
a cover including a first end and a second end and defining a longitudinal axis, wherein the multi-core fiber connector is arranged at the the first end along the longitudinal axis and the multi-fiber connector is arranged at the second end along the longitudinal axis;
a single multi-core optical fiber positioned within the cover along the longitudinal axis and at least partially received in the multi-core fiber connector;
a multi-core divider positioned within the cover along the longitudinal axis configured to receive an end of the single multi-core optical fiber, wherein the multi-core divider is configured to divide the single multi-core optical fiber into a plurality of single-core optical fibers; and
wherein the multi-core fiber connector is configured so as to arrange cores of the single multi-core optical fiber with respect to cores of a connected input cable.

2. The fiber optic system of claim 1, wherein the connected input cable further comprises an input connector that is configured to connect with multi-core single-fiber connector.

3. The fiber optic system of claim 2, wherein the input connector and the multi-core single-fiber connector are configured so that cores of the input cable are aligned with cores of the single multi-core optical fiber.

4. The fiber optic system of claim 3, wherein alignment of the input cable and the single multi-core optical fiber includes rotational alignment of cores within the input cable and cores within the single multi-core optical fiber.

5. The fiber optic system of claim 1, wherein the single multi-core optical fiber contains four optical cores and the multi-core divider is configured to divide the single multi-core optical fiber into four single-core optical fibers.

6. The fiber optic system of claim 1, wherein each core of the single multi-core optical fiber is configured to transmit a distinct optical signal.

7. The fiber optic system of claim 1, wherein the connected input cable is connected to the multi-core fiber adapter by an LC connector.

8. The fiber optic system of claim 1, wherein the plurality of single-core optical fibers are each arranged to have an end at a multi-fiber connector.

9. The fiber optic system of claim 8, wherein the multi-fiber connector is an MPO connector.
